(19) United States
(12) Patent Application Publication
(10) Pub. No.: US 2014/0095336 A1
(43) Pub. Date: Apr. 3, 2014

(54) SYSTEM AND METHOD FOR PROVIDING VEHICLE VALUATION MANAGEMENT

(71) Applicants: Chris Raulerson, Atlanta, GA (US); Mary Sargent, McDonough, GA (US); John Case Gulden, Atlanta, GA (US); Tammy Elliott, Locust Grove, GA (US); Craig Roberts, Alpharetta, GA (US); Robert O. Ward, Atlanta, GA (US); Mark Z. Cataldo, Temple, GA (US); Robert H. Garner, Snellville, GA (US); Joseph S. Garner, JR., Stockbridge, GA (US)

(72) Inventors: Chris Raulerson, Atlanta, GA (US); Mary Sargent, McDonough, GA (US); John Case Gulden, Atlanta, GA (US); Tammy Elliott, Locust Grove, GA (US); Craig Roberts, Alpharetta, GA (US); Robert O. Ward, Atlanta, GA (US); Mark Z. Cataldo, Temple, GA (US); Robert H. Garner, Snellville, GA (US); Joseph S. Garner, JR., Stockbridge, GA (US)

(73) Assignee: NEWELL RECYCLING, LLC., East Point, GA (US)

(21) Appl. No.: 13/951,432

(22) Filed: Jul. 25, 2013

Related U.S. Application Data
(60) Provisional application No. 61/675,636, filed on Jul. 25, 2012.

(51) Int. Cl. G06Q 10/00; G06Q 30/06

(52) U.S. Cl. CPC G06Q 10/30; G06Q 30/0611
USPC 705/26.4

(57) ABSTRACT

The exemplary embodiments of the present invention provide a system and method for providing vehicle valuation management services on a computer system. The computer system includes a tangible storage medium readable by the instruction processing system and storing instructions for execution by the instruction processing system. The method comprises receiving a request from a client for a value quote of a vehicle, and determining the curb weight of the vehicle. The method further comprises determining estimated freight costs to obtain the vehicle, and sending the value quote of the vehicle to the client.

### CROSS-REFERENCE TO RELATED APPLICATIONS

This application claims the benefit of U.S. Provisional Patent Application 61/675,636, filed on Jul. 25, 2012, entitled “SYSTEM AND METHOD FOR PROVIDING VEHICLE VALUATION MANAGEMENT”, which is incorporated by reference herein in its entirety.

### BACKGROUND OF THE INVENTION

1. Field of the Invention

The present invention generally relates to a calculation of a vehicle's (automobile) value as scrap metal; and more particularly to a system and method of delivering vehicle valuation determination and management.

2. Description of Background

When a vehicle such as an automobile is damaged or suffers a systems/component failure that is not worth the cost of fixing, the owner may try to find a profitable way to dispose of the vehicle. In the case of an insured accident, the owner would file a claim with an insurance carrier. A claims adjuster typically inspects the vehicle to determine the amount of damage and the costs required to repair the automobile. If the repair costs exceed the value of the automobile, or a percentage of the vehicle's value, the adjuster may “total” the vehicle. The owner may then receive a check equal to the value of the automobile.

The most common method of disposition is for the insurance company to send all total losses to salvage auctions, which sell to the highest bidder.

Therefore, a need exists in the art for a simplified system and method to both value scrap vehicles and track vehicles being transported from a client's initial location to a recycler.

### SUMMARY OF THE INVENTION

Embodiments of the present invention provide a system, method and computer program products for providing vehicle valuation and management services on a computer system.

An exemplary embodiment includes a method for delivering vehicle valuation management embodied in a computer program product for execution on an instruction processing system. The computer system comprises a tangible storage medium readable by computer system and storing instructions for execution by the instruction processing system for performing the method. The method comprises receiving a request from a client for a value quote of a vehicle, and determining the curb weight of the vehicle. The method further comprises determining estimated freight cost to obtain the vehicle, and sending the value quote of the vehicle to the client.

Another exemplary embodiment includes a system for providing vehicle valuation management services on a computer system. Briefly described in terms of architecture, one embodiment of the system, among others, is implemented as follows: The system includes a tangible storage medium readable by the computer system and storing instructions for execution by the computer system. The system further includes a means for receiving a request from a client for a value quote of a vehicle, and a means for determining the curb weight of the vehicle. The system further includes a means for determining estimated freight cost to obtain the vehicle, and a means for sending the value quote of the vehicle to the client.

A further exemplary embodiment includes a computer program product for providing vehicle valuation management services on a computer system. The computer program product includes a tangible storage medium readable by a computer system and storing instructions or execution by the computer system for performing a method. The method comprises receiving a request from a client for a value quote of a vehicle, and determining the curb weight of the vehicle. The method further comprises determining estimated freight cost to obtain the vehicle, and sending the value quote of the vehicle to the client.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed

### BRIEF DESCRIPTION OF THE DRAWINGS

The subject matter, which is regarded as the invention, is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of the network environment for the vehicle valuation management services of the present invention.

FIG. 2A is a block diagram illustrating an example of a server utilizing the vehicle valuation management system of the present invention, as shown in FIG. 1.

FIG. 2B is a block diagram illustrating an example of a remote device utilizing the vehicle valuation management system of the present invention, as shown in FIG. 1.

FIG. 3 is a flow chart illustrating an example of the operation of vehicle valuation management system of the present invention utilized by the server, as shown in FIGS. 1-2A.

FIG. 4 is a flow chart illustrating an example of the operation of the customer configure process on the server that is utilized in the vehicle valuation management system of the present invention, as shown in FIGS. 2-3.

FIG. 5 is a flow chart illustrating an example of the operation of the vehicle analysis process on the server that is utilized in the vehicle valuation management system of the present invention, as shown in FIGS. 2-3.

FIG. 6 is a flow chart illustrating an example of the operation of the value adjustment process on the server that is utilized in the vehicle valuation management system of the present invention, as shown in FIGS. 2-3.

FIG. 7 is a flow chart illustrating an example of the operation of the freight cost process on the server that is utilized in the vehicle valuation management system of the present invention, as shown in FIGS. 2-3

FIG. 8 is a flow chart illustrating an example of the operation of the quote process on the server that is utilized in the vehicle valuation management system of the present invention, as shown in FIGS. 2-3.

FIG. 9 is a flow chart illustrating an example of the operation of the specific part request process on the server that is utilized in the vehicle valuation management system of the present invention, as shown in FIGS. 2-3.

FIG. 10 is a flow chart illustrating an example of the operation of the vehicle status reports process on the server that is utilized in the vehicle valuation management system of the present invention, as shown in FIGS. 2-3.

The detailed description explains the preferred embodiments of the invention, together with advantages and features, by way of example with reference to the drawings.

### DETAILED DESCRIPTION OF THE INVENTION

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

The invention described hereafter is applicable on all remote devices connected to a server hosting the vehicle valuation management system and method of the present invention. While described below with respect to a single computer, the system and method for a webpage build system is typically implemented in a networked computing environment in which a number of computing devices communicate over a local area network (LAN), over a wide area network (WAN), or over a combination of both LAN and WAN.

The vehicle valuation management system in accordance with one example embodiment of the present invention can be used to determine price adjustment values for scrap vehicles. Initially, it should be understood that the term “vehicle” is used broadly herein to encompass a variety of transportation devices. For example, vehicles include automobiles of all types, motorized cycles including motorcycles and all terrain vehicles, boats, watercraft, airplanes, etc. In this regard, the present invention may be implemented in the manner described to determine price adjustment values for such vehicles. Thus, although the example embodiment discussed in detail below focuses on automobiles, it should be understood that the present invention is not limited thereto but may be implemented to determine vehicle price adjustment values for any vehicle.

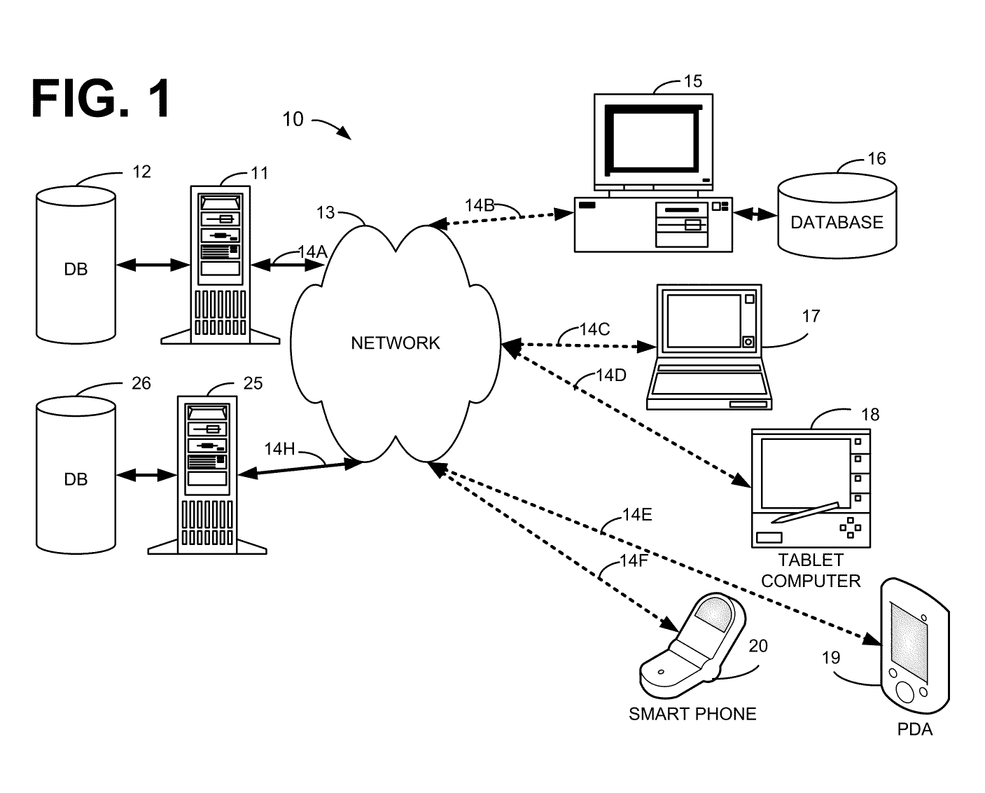

Referring now to the drawings, in which like numerals illustrate like elements throughout the several views. FIG. 1 illustrates an example of the basic components of a system 10 using the vehicle valuation management system used in connection with the preferred embodiment of the present invention. The system 10 includes a server 11 and the remote devices 15 or 17-20 that utilize the vehicle valuation management system of the present invention.

Each remote device 15 and 17-20 has applications and can have a local database 16. Server 11 contains applications, and a database 12 that can be accessed by remote device 15 and 17-20 via connections 14(A-C), respectively, over network 13. The server 11 runs administrative software for a computer network and controls access to itself and database 12. The remote device 15 and 17-20 may access the database 12 over a network 13, such as but not limited to: the Internet, a local area network (LAN), a wide area network (WAN), via a telephone line using a modem (POTS), Bluetooth, WiFi, cellular, optical, satellite, RF, Ethernet, magnetic induction, coax, RS-485, or other like networks. The server 11 may also be connected to the local area network (LAN) within an organization (i.e. a hospital or university complex).

The remote device 15 and 17-20 may each be located at remote sites. Remote device 15 and 17-20 include but are not limited to, PCs, workstations, laptops, handheld computer, pocket PCs, PDAs, pagers, WAP devices, non-WAP devices, cell phones, smart phones, tablet computers, palm devices and the like. Included with each remote device 15 and 17-20 is an ability to input and output text data and provide images of the vehicle. In the remote device 15, there is a camera for capturing images of a vehicle. In remote devices, 17-20, may include integrated cameras for acquiring images of the vehicle or the ability to download photographs of a vehicle in a digital form. The images can be used to verify VIN numbers, accessories, and the condition of the vehicle.

Thus, when a user of one of the remote devices 15 and 17-20 desires to access vehicle valuation management services status from the database 12 at the server 11, the remote device 15 and 17-20 communicate over the network 13, to access the server 11 and database 12.

Third party vendors' computer systems 21 and databases 22 can be accessed by the vehicle valuation management system 100 on server 11 in order to access vehicle valuations, specific part request, freight costs, VIN-specific recyclable value for specific parts, Average Cash Value (ACV) for comparison purposes and the like. Data that is obtained from third party vendors' computer system 21 and databases 22 can be stored on server 11 and database 12 in order to provide later access to the user on remote devices 15 and 17-20. It is also contemplated that for certain types of data that the remote devices 15 and 17-20 can access the third party vendors' computer systems 21 and database 22 directly using network 13.

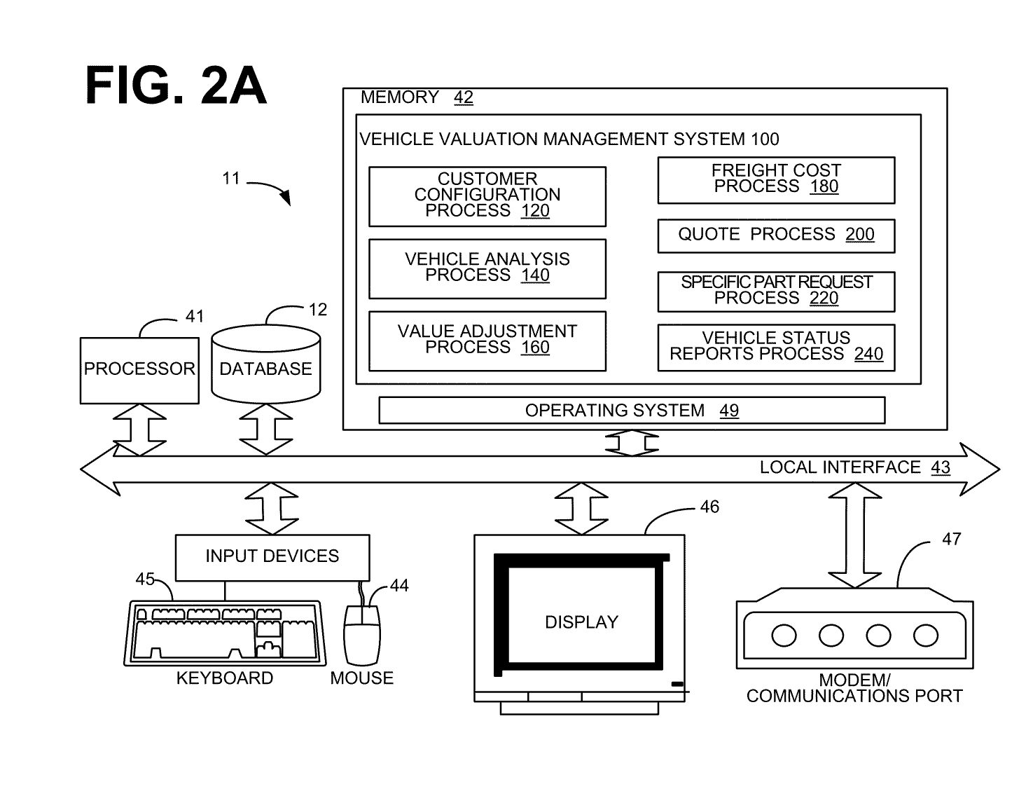

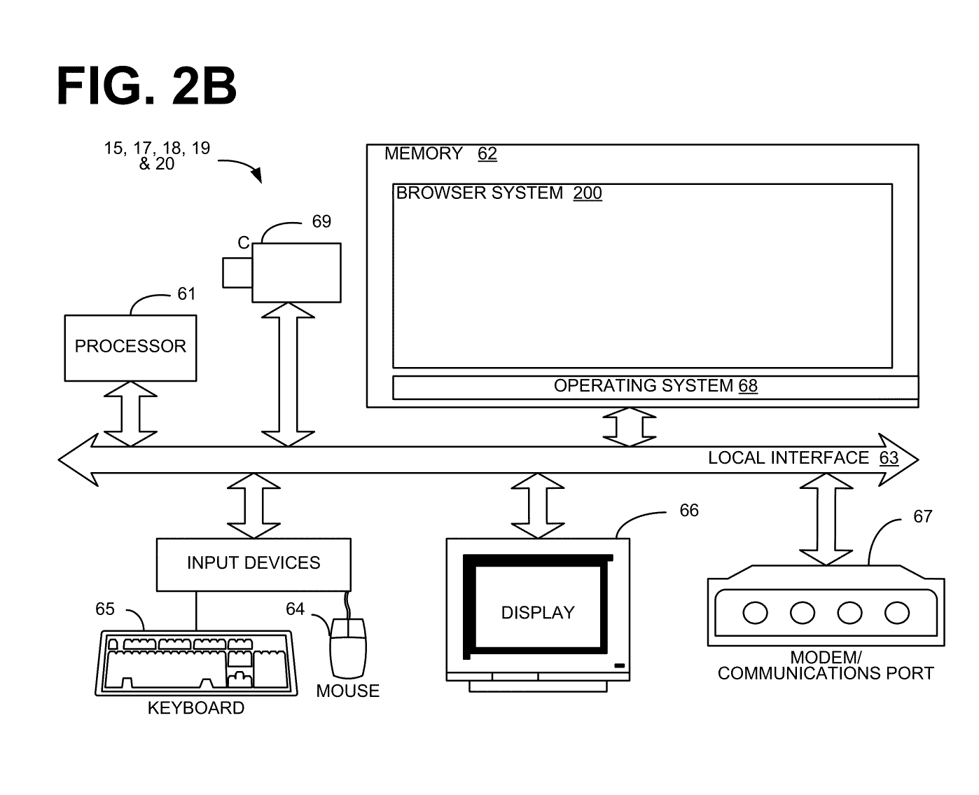

Illustrated in FIG. 2A is a block diagram demonstrating an example of server 11, as shown in FIG. 1, utilizing the vehicle valuation management system 100 of the present invention. Server 11 includes, but is not limited to, PCs, workstations, racks, laptops, PDAs, palm devices and the like. Illustrated in FIG. 2B is an example demonstrating a remote device's 15 and 17-20 utilizing the remote device system 200 of the present invention. The processing components of the third party vendor's computer systems 21 are similar to that of the description for the server 11 (FIG. 2A).

Generally, in terms of hardware architecture, as shown in FIG. 2A, the server 11 includes a processor 41, memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP) or an auxiliary processor among several processors associated with the server 11, and a semiconductor based microprocessor (in the form of a microchip) or a macroprocessor. Examples of suitable commercially available microprocessors are as follows: an 80×86 or Pentium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM), such as dynamic random access memory (DRAM), static random access memory (SRAM), etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 can have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 2A, the software in the memory 42 includes a suitable operating system (O/S) 49 and the vehicle valuation management system 100 of the present invention. As illustrated, the vehicle valuation management system 100 of the present invention comprises numerous functional components including, but not limited to, the client configure process 120, vehicle analysis process 140, value adjustment process 160, freight cost process 180, quote process 200, specific part request process 220 and vehicle status reports process 240.

A non-exhaustive list of examples of suitable commercially available operating systems 49 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., PalmOS available from Palm Computing, Inc., and Windows CE available from Microsoft Corporation).

The operating system 49 essentially controls the execution of other computer programs, such as the vehicle valuation management system 100, and provides scheduling, input-output control, file and data management, memory management, and communication control and related services. However, it is contemplated by the inventors that the vehicle valuation management system 100 of the present invention is applicable on all other commercially available operating systems.

The vehicle valuation management system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the O/S 49. Furthermore, the vehicle valuation management system 100 can be written as (a) an object oriented programming language, which has classes of data and methods, or (b) a procedure programming language, which has routines, subroutines, and/or functions, for example but not limited to, C, C++, C#, Pascal, BASIC, API calls, HTML, XHTML, XML, ASP scripts, FORTRAN, COBOL, Perl, Java, ADA, .NET, and the like.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 pursuant to the software. The vehicle valuation management system 100 and the O/S 49 are read, in whole or in part, by the processor 41, perhaps buffered within the processor 41, and then executed.

When the vehicle valuation management system 100 is implemented in software, as is shown in FIG. 2A, it should be noted that the vehicle valuation management system 100 can be embodied in any computer-readable medium, for use by or in connection with, an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example, but not limited to, an electronic, magnetic, optical, electromagnetic, infrared, or semiconductor system, apparatus, device, propagation medium, or other physical device or means that can contain or store a computer program for use by or in connection with a computer related system or method.

More specific examples (a nonexhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD RAN) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

In an alternative embodiment, where the vehicle valuation management system 100 is implemented in hardware, the vehicle valuation management system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of functional elements in the remote device 15 and 17-20, that enables access to the vehicle valuation management system 100 of the present invention, as shown in FIG. 2A. The remote devices 15 and 17-20 provide access to the vehicle valuation management system 100 of the present invention on server 11 and database 12 using the remote devices system 60, including for example, but not limited to an Internet browser. The information accessed in server 11 and database 12 can be provided in the number of different forms including but not limited to ASCII data, WEB page data (i.e. HTML), XML or other type of formatted data.

Included with each remote device 15 and 17-20 is an ability to obtain images of the vehicle. In the remote device 15, there is a camera 69 for capturing images of the vehicle. In remote devices 17 and 18, they may be integrated cameras 69 for acquiring images of the vehicle or the ability to download photographs of the vehicle in a digital form.

As illustrated, the remote device 15 and 17-20 are similar to the description of the components for server 11 described with regard to FIG. 2A. Hereinafter, the remote devices 15 and 17-20 will be referred to as remote devices 15 for the sake of brevity.

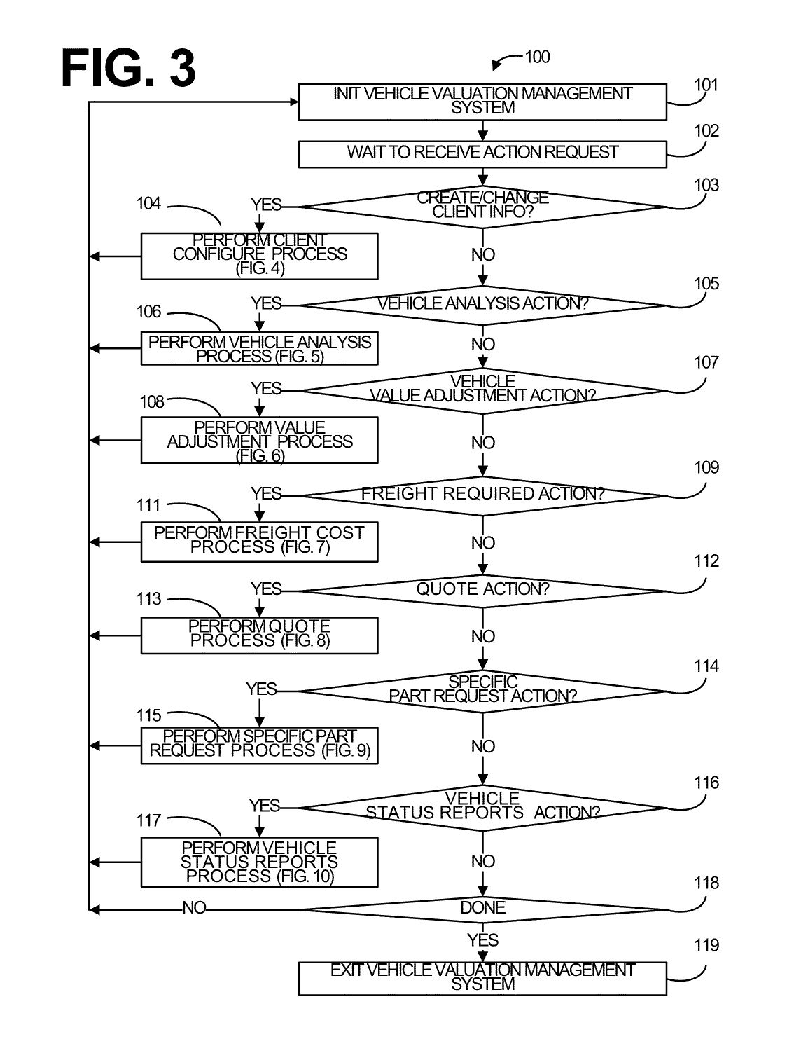

FIG. 3 is a flow chart illustrating an example of the operation of the vehicle valuation management system 100 of the present invention utilized by the server 11, as shown in FIG. 2A. The vehicle valuation management system 100 of the present invention provides a client with the ability to acquire a quote for the valuation of a vehicle.

First at step 101, the vehicle valuation management system 100 is initialized. This initialization includes the startup routines and processes embedded in the BIOS of the server 11. The initialization also includes the establishment of data values for particular data structures utilized in the vehicle valuation management system 100.

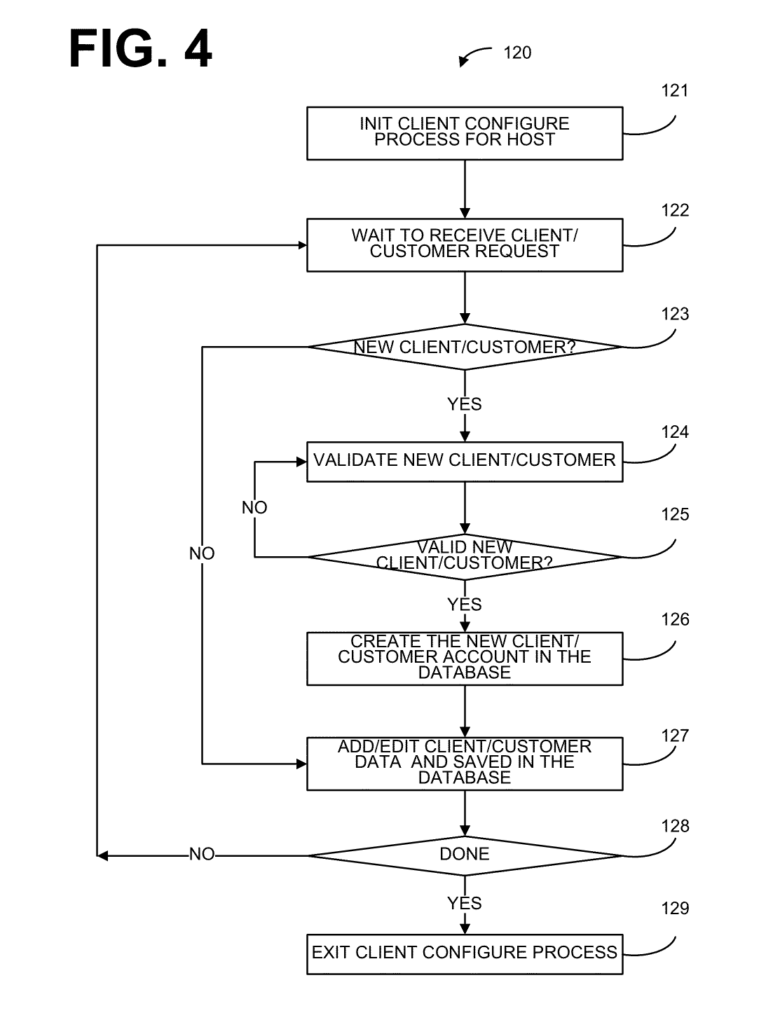

At step 102, the vehicle valuation management system 100 waits to receive an action request. Once an action is received at step 102, it is determined if the action is to add/modify client information at step 103. If it is determined that the action is not to add/modify client information, then the vehicle valuation management system 100 skips to step 105. However, if it is determined in step 103 that the action is to add/modify client information, then the vehicle valuation management system 100 performs the client configure process at step 104. The client configure process is herein defined in further detail with regard to FIG. 4. After performing the client configure process, the vehicle valuation management system 100 returns to step 102.

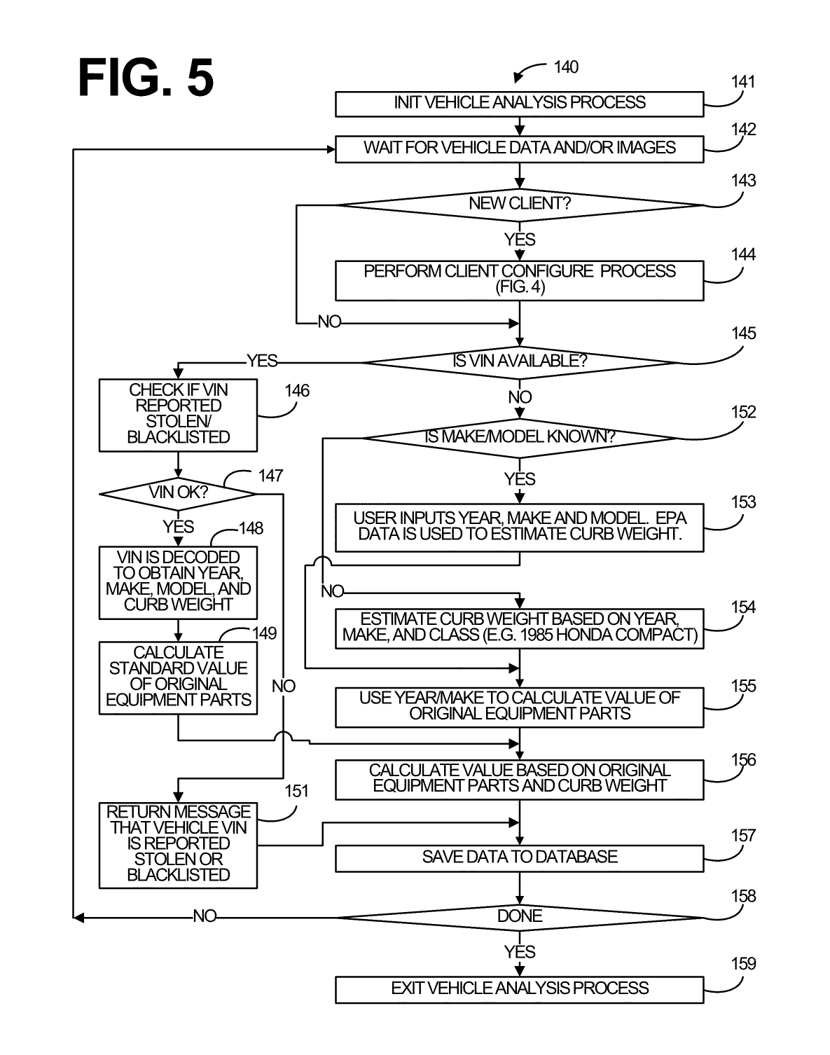

At step 105, it is determined if the action is a vehicle analysis action, i.e. calculate the vehicle valuation. If it is determined that the action is not a vehicle analysis action, then the vehicle valuation management system 100 skips to step 107. However, if it is determined in step 105 that it is a vehicle analysis action, then the vehicle valuation management system 100 performs the vehicle analysis process at step 106. The vehicle analysis process is herein defined in further detail with regard to FIG. 5. After performing the vehicle analysis process, the vehicle valuation management system 100 returns to step 102.

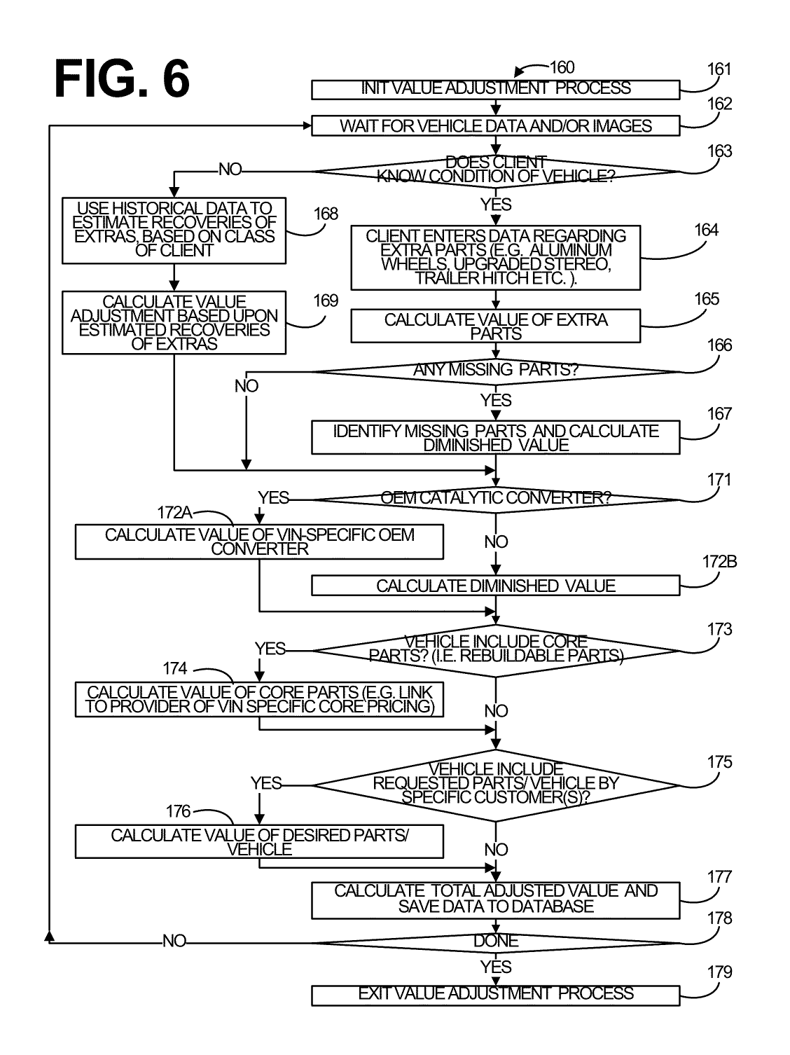

At step 107, it is determined if the action is a vehicle value adjustment action, i.e. the vehicle valuation is adjusted due to missing parts, add-on parts, core parts or customer desired part. If it is determined that the action is not a vehicle value adjustment action, then the vehicle valuation management system 100 skips to step 109. However, if it is determined at step 107 that it is a vehicle value adjustment action, then the vehicle valuation management system 100 performs the vehicle value adjustment process at step 108. The vehicle value adjustment process is herein defined in further detail with regard to FIG. 6. After performing the vehicle value adjustment process, the vehicle valuation management system 100 returns to step 102.

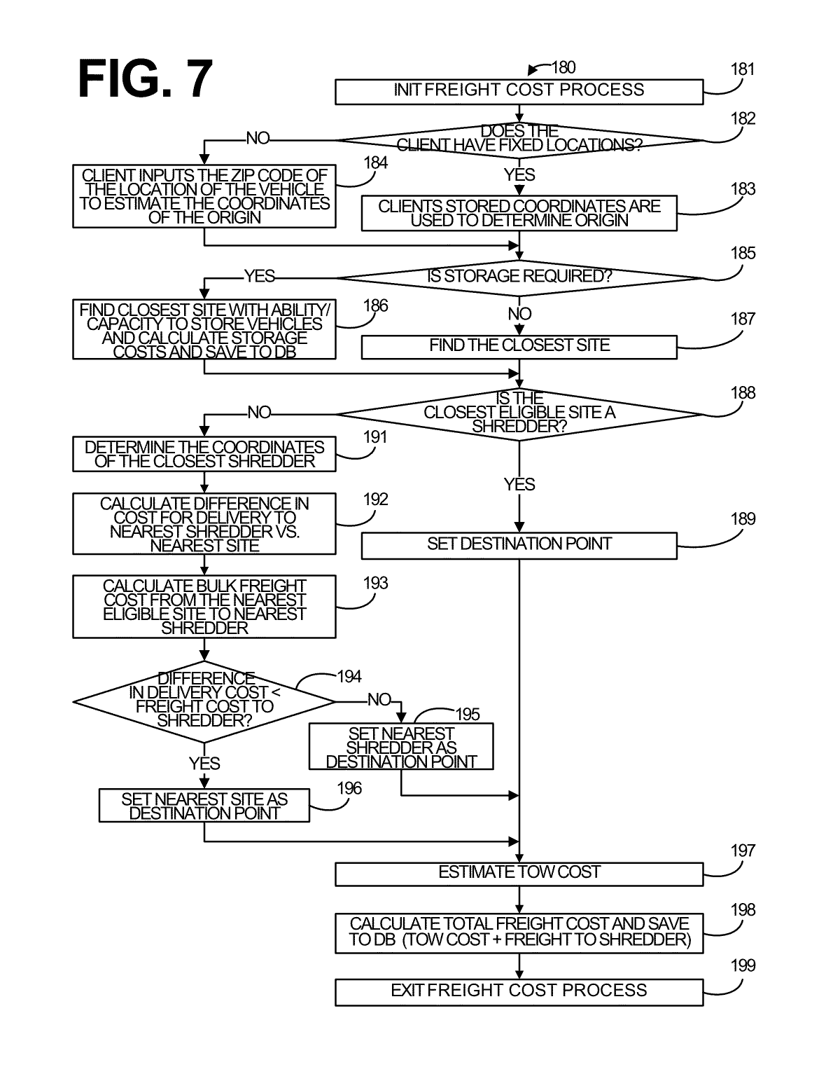

At step 109, it is determined if the action is a freight required action, i.e. the freight costs are calculated if transportation is needed for the vehicle. If it is determined that the action is not a freight required action, then the vehicle valuation management system 100 skips to step 112. However, if it is determined at step 109 that it is a freight required action, then the vehicle valuation management system 100 performs the freight required process at step 111. The freight required process is herein defined in further detail with regard to FIG. 7. After performing the freight required process, the vehicle valuation management system 100 returns to step 102.

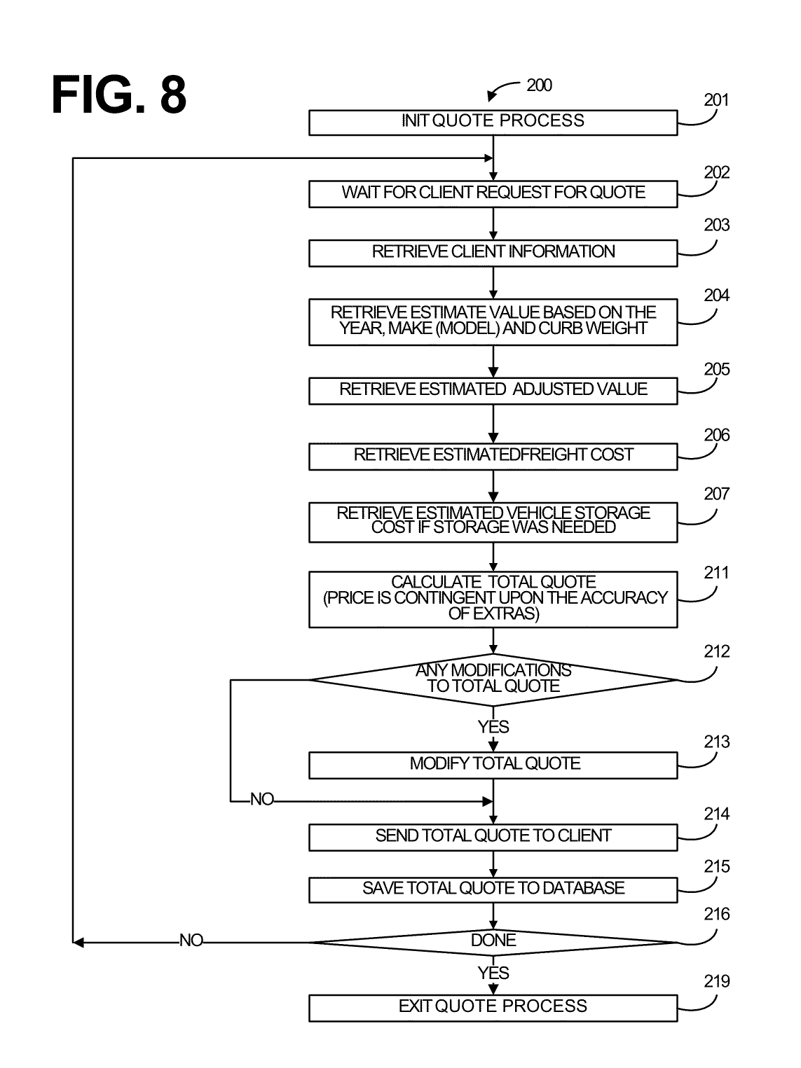

At step 112, it is determined if the action is a quote action. A quote action is a situation where the vehicle valuation management system 100 calculates the total quote and sends the total quote to the client. If it is determined that the action is not a quote action, then the vehicle valuation management system 100 skips to step 114. However, if it is determined at step 112 that a quote action is to be performed, then the vehicle valuation management system 100 performs the quote process at step 113. The quote process is herein defined in further detail with regard to FIG. 8. After performing the quote process, the vehicle valuation management system 100 returns to step 102.

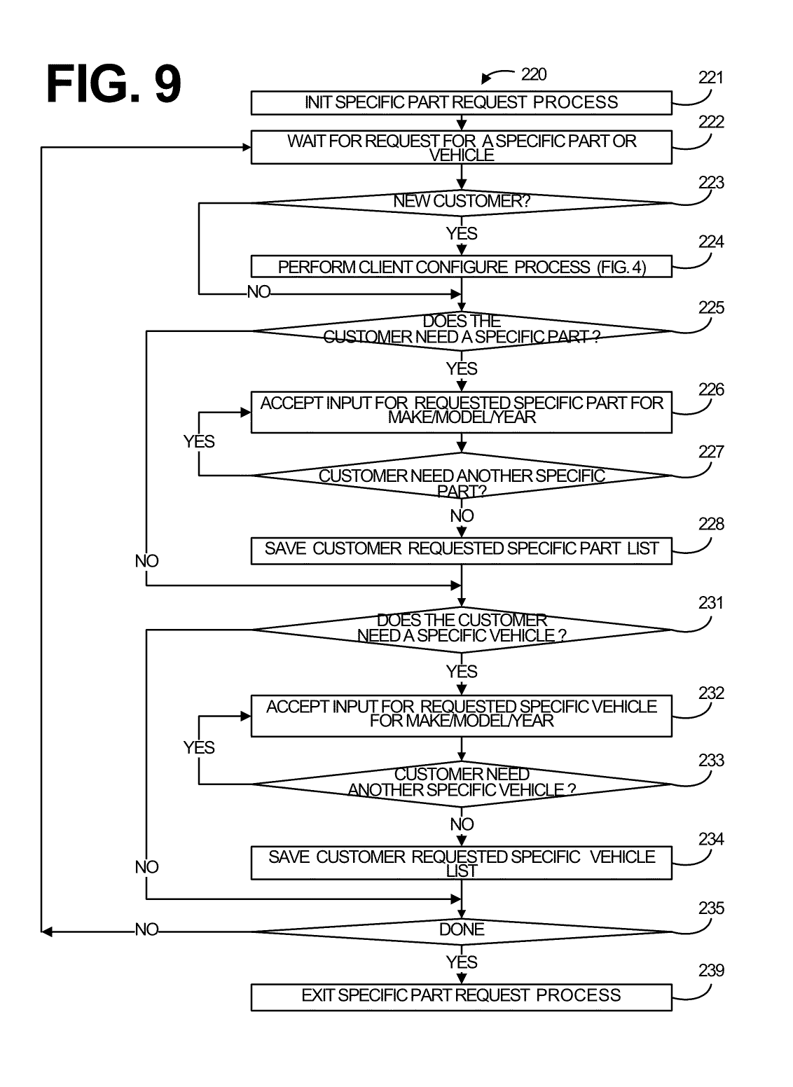

At step 114, it is determined if the action is a specific part request action, i.e. determines if a customer has requested a specific part for a vehicle. If it is determined that the action is not a specific part request action, then the vehicle valuation management system 100 skips to step 116. However, if it is determined at step 114 that it is a specific part request action, then the vehicle valuation management system 100 performs the specific part request process at step 115. The specific part request process is herein defined in further detail with regard to FIG. 9. After performing the specific part request process, the vehicle valuation management system 100 returns to step 102.

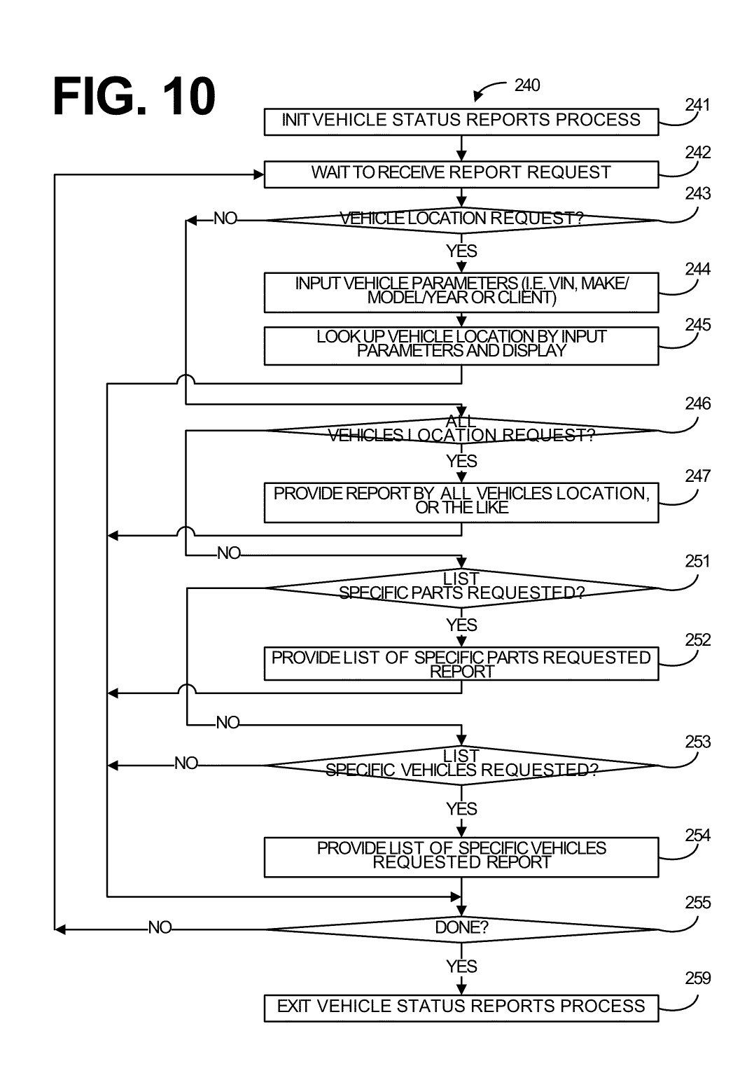

At step 116, it is determined if the action is a vehicle status reports action. A vehicle status reports action is a situation where the vehicle valuation management system 100 provides reports of a number of different situations including, but not limited to a vehicle location, all vehicles location, list of specific parts requested and a list of specific vehicles requested reports. If it is determined that the action is not a vehicle status reports action, then the vehicle valuation management system 100 skips to step 118. However, if it is determined at step 116 that a vehicle status reports action is to be performed, then the vehicle valuation management system 100 performs the vehicle status reports process at step 117. The vehicle status reports process is herein defined in further detail with regard to FIG. 10. After performing the vehicle status reports process, the vehicle valuation management system 100 returns to step 102.

At step 118, it is determined if the vehicle valuation management system 100 is to wait for additional action request. If it is determined at step 118 that the vehicle valuation management system 100 is to wait to receive additional actions, then the vehicle valuation management system 100 returns to repeat steps 102 through 118. However, if it is determined at step 118 that there are no more actions to be received, then the vehicle valuation management system 100 then exits at step 119.

FIG. 4 is a flow chart illustrating an example of the operation of the client configure process 120 on the server 11 that is utilized in the vehicle valuation management system 100 of the present invention, as shown in FIGS. 2A-3. The client configure process 120 enables a user to establish/modify client/customer specific information residing on database 12 (FIG. 2A). Clients are referred to as entities that provide vehicles to be evaluated and managed by the vehicle valuation management system 100, whereas customers are those entities that request a specific part by make/model/year or vehicle by make/model/year. The client configure process 120 creates and retains both client and customer data in database 12. Once the new client information is placed in server 11, the client is available for vehicle analysis and quote reception. A brief overview of one exemplary process is as follows: 1) waits to receive a client configure request; 2) determine if the client is a new client; 3) validate and store new client name; 4) upload new/modify existing client information from local machine; and 5) done.

First at step 121, the client configure process 120 is initialized. This initialization includes the startup routines and processes embedded in the BIOS of the server 11. The initialization also includes the establishment of data values for particular data structures utilized in the client configure process 120.

At step 122, the client configure process 120 waits to receive a new client/customer request. Once a new client/customer request has been received, the client configure process 120 determines if the client/customer is a new client/customer to the vehicle valuation management system 100. If it is determined at step 123 that the client/customer is not a new client/customer, then the client configure process 120 skips to step 127 to enable the client/customer to enter new or edit existing client/customer data. However, if it is determined at step 123 that the client/customer is a new client/customer, then the client configure process 120 validates the new client/customer at step 124. The new client/customer is registered at this time and is validated against information in database 12 at step 125. If the new client/customer is not valid, then the client configure process 120 returns to step 124. However, if the new client/customer is valid, then the client configure process 120 enables the new client/customer to create a new client/customer account in database 12, at step 126.

At step 127, the client configure process 120 enables the client/customer to add or edit existing client/customer data in the client account in database 12. The new or modified client/customer data is saved to database 12.

At step 128, it is determined if the client configure process 120 is to wait for additional client/customer requests. If it is determined at step 128 that the client configure process 120 is to wait for additional client/customer requests, then the client configure process 120 returns to repeat steps 122 through 128. However, if it is determined at step 128 that there are no more client/customer actions to be received, then the client configure process 120 then exits at step 129.

FIG. 5 is a flow chart illustrating an example of the operation of the vehicle analysis process 140 on the server 11 that is utilized in the vehicle valuation management system 100 of the present invention, as shown in FIGS. 2A-3. Once the new client is placed in server 11, it is available for processing clients' vehicle analysis and vehicle quotes. A brief overview of one exemplary process is as follows: 1) determine if a client account is established; 2) determine if a vehicle identification number (i.e. VIN) for the vehicle is available; 3) determine if the vehicle was reported stolen (if the VIN is available); 4) if the vehicle was reported stolen, return a message to the client that vehicle was reported stolen/blacklisted and skip to the store data step; 5) acquire vehicle original parts and curb weight information about the vehicle using the VIN and skip to the calculate value step; 6) if the VIN is unavailable, determine if the make and model of the vehicle is known; 7) if the make and model of the vehicle is known, use data to estimate curb weight and skip to use make/model to calculate value of original parts step; 8) if the make and model is not known, the client estimates the curb weight based on the year make and class of car; 9) use year/make to calculate value of original equipment parts; 10) calculate value based upon original equipment parts and curb weight; 11) save the data to the database; 12) done.

First at step 141, the vehicle analysis process 140 is initialized. This initialization includes the startup routines and processes embedded in the BIOS of the server 11. The initialization also includes the establishment of data values for particular data structures utilized in the vehicle analysis process 140.

At step 142, the vehicle analysis process 140 waits to receive a vehicle transaction. Once a vehicle transaction has been received, the vehicle analysis process 140 then verifies that the client account exists at step 143. If the client account exists, then the vehicle analysis process 140 skips to step 145. However, if a client account does not exist for the new client, then the client configure process 120 is performed at step 144.

At step 145, the vehicle analysis process 140 determines if the vehicle identification number (i.e. VIN) for the vehicle is available. If it is determined in step 145 that the VIN is not available, then the vehicle analysis process 140 skips to step 151. However, if it is determined at step 145 that the VIN is available, then the VIN is checked to see if it is ever been reported stolen or has a lien on it at step 146. At step 147, it is determined if the vehicle was reported stolen or blacklisted. If it is determined that the vehicle was reported stolen or has a lien on it, then the vehicle analysis process 140 skips to step 151 to return a message to the client that vehicle was reported stolen or has a lien on it and skips to step 157.

However, if it is determined at step 147 that the VIN is okay, then the VIN is decoded to obtain the year/make/model and curb weight of the vehicle at step 148. At step 149, the standard value of the original equipment parts is calculated using the VIN for the vehicle. The vehicle analysis process 140 then skips to step 156.

At step 152, it is determined if the make/model of the vehicle is known. If it is determined at step 152 that the make/model of the vehicle is not known, then the vehicle analysis process 140 skips to step 154. However, if the make/model of the vehicle is known, the user inputs the year, make and model data into the vehicle analysis process 140, so that the curb weight can be estimated, at step 153. In the preferred embodiment, vehicle manufactures data is used to estimate curb weight for a known year, make and model of a vehicle. However, it is understood that other databases containing this information can be utilized. These databases include, but are not limited to Kelley blue book data, Edmonds data, Autotrader data, and the like. The vehicle analysis process 140 then skips to step 155.

At step 154, the client inputs the year, make and class of the vehicle so that the vehicle analysis process 140 can estimate curb weight. In the preferred embodiment, this information is obtained from the vehicle analysis process 140, based on past vehicle input. However, other sources for this data can be utilized, such as for example but not limited to, vehicle manufactures data, Kelley blue book data, Edmonds data, Autotrader data, and the like.

At step 155, the vehicle analysis process 140 uses the year/make to calculate the value of the original equipment parts. In the preferred embodiment, this information is obtained from the vehicle analysis process 140, based on past vehicle input. However, other sources for this data can be utilized, such as for example, but not limited to, vehicle manufactures data, Kelley blue book data, Edmonds data, Autotrader data, and the like.

At step 156, value of the vehicle is calculated based upon original equipment parts and curb weight. The curb weight component simply multiplies a price per lb*the curb weight. In the preferred embodiment, the value of original equipment is based on a series of tables that classifies the manufacturer and year. Each class of manufacturer and year is associated with a specific value for their converter and the presence of aluminum wheels. A separate table classifies the different converter grades, and these are linked together to estimate a scrap price for the converter. For the aluminum wheels, if it is predicted the aluminum wheels are on the vehicle, then the average weight of aluminum wheels*market price are added. At step 157, all the information collected in the execution of the vehicle analysis process 140 is entered into database 12.

At step 158, it is determined if the vehicle analysis process 140 is to wait for additional vehicle transactions. If it is determined at step 158 that the vehicle analysis process 140 is to wait for additional vehicle transactions, then the vehicle analysis process 140 returns to repeat steps 142 through 158. However, if it is determined at step 158 that there are no more vehicle transactions to be received, then the vehicle analysis process 140 then exits at step 159.

FIG. 6 is a flow chart illustrating an example of the operation of the value adjustment process 160 on the server 11 that is utilized in the vehicle valuation management system 100 of the present invention, as shown in FIGS. 2A-3. The client provides data input and/or images describing the condition of the vehicle, any additional or missing parts with the vehicle, if the vehicle includes any core parts (i.e. re-buildable) or if the vehicle includes requested parts/vehicle by a specific customer. All these conditions are considered when calculating adjusted value of the vehicle. A brief overview of one exemplary process is as follows: 1) determine if the client knows the condition of the vehicle; 2) If the client does not know the condition of the vehicle, use historical data to estimate recovery based upon class of the client and calculate the value adjustments based upon estimated recoveries; 3) If the client does know the condition of the vehicle, the client provides data input and/or images describing any additional or missing parts on the vehicle; 4) determine if the vehicle includes any core (i.e. re-buildable parts) and calculate their value; 5) determine if the vehicle includes any requested parts/vehicle by specific customers and calculate their value; 6) calculate the total adjusted value of the vehicle; 7) save the data to database 12; and 8) done.

At step 161, the value adjustment process 160 is initialized. This initialization includes the startup routines and processes embedded in the BIOS of the server 11. The initialization also includes the establishment of data values for particular data structures utilized in the value adjustment process 160.

At step 162, the value adjustment process 160 waits to receive a vehicle transaction. Once a vehicle transaction has been received, the value adjustment process 160 then determines if the client knows the condition of the vehicle at step 163. If it is determined that the client does not know the condition of the vehicle, then the value adjustment process skips to step 168. However, if it is determined that the client knows the condition of the vehicle, the client provides data input and/or images describing any original or replacement parts on the vehicle (e.g. engine, transmission, differential, axel(s), airbags/gold connectors, tires, aluminum wheels, and the like) at step 164. The images may be acquired by a camera on the remote device 15 or downloaded from an image-acquiring device (not shown) to memory 42 utilizing any communication means. The communication means include, but are not limited to, USB, FireWire, diskette, CD-ROM, attached e-mail, or the like.

At step 165, the value adjustment process 160 calculates the value of the extra parts. At step 166, it is determined if the client knows of any missing parts from the vehicle. If it is determined at step 166 at the client does not know of any missing parts, then the value adjustment process 160 skips to step 171. However, if it is determined at step 166 that the client does know of missing parts, then the missing parts are identified at step 167. After identifying the missing parts, the value adjustment process 160 calculates the diminished value of the vehicle and then skips to step 171. In the preferred embodiment, the added value that was estimated in the vehicle analysis process 140 (FIG. 5) is simply removed. For other non-value adds, a flat pricing schedule to diminish the value. For example, but not limited to, if motor is not present then a flat rate deduction of $50 is made and if transmission is not present then a flat rate deduction of $45 is made.

At step 168, the value adjustment process 160 uses historical data to estimate recovery of extra value based upon class of the client. At step 169, the value adjustment process 160 calculates the value adjustments based upon estimated recoveries.

At step 171, it is determined if the vehicle includes the original or factory replacement catalytic converter(s) (i.e. OEM catalytic converter). If it is determined that the vehicle does include the OEM catalytic converter, then the value adjustment process 160 calculates the specific value for the OEM converter at step 172A. The value adjustment process 160 then skips to step 173. Each class of manufacturer and year is associated with a specific value for the OEM converter. In the preferred embodiment, historical data stored within the vehicle valuation management system 100 of the present invention can be utilized to calculate the increased value of the OEM converter. However, in an alternative embodiment a link to a third party is used to determine the value of the OEM converter.

However, if it is determined that the vehicle does not include the OEM catalytic converter, then the value adjustment process 160 calculates the reduced value of the replacement part(s) at step 172B. In the preferred embodiment, historical data stored within the vehicle valuation management system 100 of the present invention can be utilized to calculate the reduced value of the replacement part(s). However, in an alternative embodiment link to a provider of the replacement part(s) is utilized.

At step 173, it is determined if the vehicle includes core parts (i.e. re-buildable parts). If it is determined that the vehicle does not include any core parts, then the value adjustment process 160 skips to step 175. However, if it is determined that the vehicle does include core parts, then the value adjustment process 160 calculates the value of the core parts at step 174. In the preferred embodiment, an Internet link (i.e. URL) to a provider of specific core pricing is utilized. However, historical data stored within the vehicle valuation management system 100 of the present invention can also be utilized to calculate their value.

At step 175, it is determined if the vehicle includes any requested parts or the vehicle is requested by a customer. If it is determined that the vehicle does not include any requested parts or the vehicle is not requested by a customer, then the value adjustment process 160 skips to step 177. However, if it is determined that the vehicle does include requested parts or the vehicle is requested by a customer, then the value adjustment process 160 calculates the value of the requested parts or the vehicle, at step 176. In the preferred embodiment, a percentage of the quoted price the customer would pay for the desired part/vehicle is utilized to determine the value of the part/vehicle. The valuation percentage is generally in the range of 20%-80% of the quoted price. However, historical data stored within the vehicle valuation management system 100 of the present invention can also be utilized to calculate the value of the requested parts/vehicle.

At step 177, the value adjustment process 160 calculates the total adjusted value of the vehicle. At step 176, the data generated in the value adjustment process 160 is saved to database 12.

At step 178, it is determined if the value adjustment process 160 is to wait for additional vehicle value adjustment transactions. If it is determined at step 178 that the value adjustment process 160 is to wait for additional vehicle value adjustment transactions, then the value adjustment process 160 returns to repeat steps 162 through 178. However, if it is determined at step 178 that there are no more vehicle value adjustment transactions to be received, then the value adjustment process 160 exits at step 169.

FIG. 7 is a flow chart illustrating an example of the operation of the freight cost process 180 on the server 11 that is utilized in the vehicle valuation management system 100 of the present invention, as shown in FIGS. 2A-3. The freight cost process 180 enables the vehicle valuation management system 100 to establish total freight costs to recover a vehicle. The total freight costs include any storage costs and freight costs to the destination point. Once total freight costs to recover a vehicle are calculated, the value of the vehicle can be determined for a client quote. A brief overview of one exemplary process is as follows: 1) determine if the client has a fixed location; 2) if the client does not have a fixed location, then the client inputs the ZIP code/address of the location of the vehicle as the origin; 3) if the client has a fixed location, the stored coordinates are used to determine the origin; 4) it is then determined if storage is required for the vehicle; 5) if storage is required, then the closest site is determined with the ability and capacity to store a vehicle; 6) if storage is not required, the closest site is determined; 7) determine if the closest eligible site is a shredder; 8) if the closest eligible site is as shredder, then that is set as the destination point; 9) if the closest eligible site is not a shredder, then determine the coordinates of the closest shredder; 10) calculate the difference in cost for delivery to nearest shredder versus nearest site; 11) calculate bulk freight cost from nearest eligible site to nearest shredder; 12) determine the difference in delivery cost to nearest shredder versus bulk freight cost from nearest eligible site to the nearest shredder; 13) set nearest shredder as destination point if delivery cost to nearest shredder is less than delivery cost to nearest site and bulk freight from nearest site to nearest shredder; 14) set nearest site as destination point if delivery cost to nearest site plus, bulk freight costs from nearest site to nearest shredder is less than the delivery cost to nearest shredder; 15) estimate towing costs; 16) calculate total freight cost and save to database; and 17) done.

First at step 181, the freight cost process 180 is initialized. This initialization includes the startup routines and processes embedded in the BIOS of the server 11. The initialization also includes the establishment of data values for particular data structures utilized in the freight cost process 180.

At step 182, the freight cost process 180 determines if the client has a fixed location. If it is determined at step 182 that the client does not have a fixed location, then the freight cost process jumps to step 184. However, if it is determined at step 182 to client has a fixed location, then the stored coordinates for the client are used to determine the origin at step 183. The freight cost process 180 then skips to step 185.

At step 184, the client inputs the ZIP code/address of the location of the vehicle as the origin.

At step 185, it is determined if storage is required for the vehicle. If it is determined at step 185, that storage is required for the vehicle, then the freight cost process 180 determines the closes site with the ability and capacity to store a vehicle, at step 186. The storage costs are also calculated and stored for later retrieval in database 12. The freight cost process 180 then skips to step 188. However, if it is determined at step 185, that storage is not required for the vehicle, and then the freight cost process 180 determines the closest site to the origin at step 187.

At step 188, it is determined if the closest eligible site is a shredder. If it is determined at step 188 that the closest available site is a shredder, then the freight cost process 180 sets the destination point to the shredder as the closest available site, at step 189, and then the freight cost process 180 skips to step 197. However, if it is determined at step 188 that the closest eligible site is not a shredder, the freight costs process 180 then determines the coordinates of the closest shredder, at step 191. At step 192, the freight cost process 180 calculates the difference in cost for delivery to near the shredder versus nearest site from the origin. At step 193, the freight cost process 180 calculates the bulk freight cost from nearest eligible site to the nearest shredder. At step 194, the freight cost process 180 determines the difference in delivery costs to the nearest shredder versus bulk freight costs from nearest eligible site to the nearest shredder. If it is determined at step 194, that the delivery cost to nearest shredder is less than delivery cost to nearest site and bulk freight from nearest site to nearest shredder, then the freight cost process 180 sets the nearest shredder as the destination point at step 195, and then the freight cost process 180 skips to step 197. However, if it is determined at step 194 that the freight costs from the nearest site to the nearest shredder are less than the delivery cost to the nearest shredder, then freight cost process 180 sets at destination point to the nearest site, at step 196.

At step 197, the freight cost process 180 estimates towing costs from the origin to the destination point. At step 198, the freight cost process 180 calculates the total freight costs and saves to database 12. The freight cost process 180 then exits at step 199

FIG. 8 is a flow chart illustrating an example of the operation of the quote process 200 on the host that is utilized in the vehicle valuation management system 100 of the present invention, as shown in FIGS. 2A-3. The client has provided all the information with regard to the estimated value based upon year, make/model and curb weight, estimated adjusted value, estimated freight costs, estimated vehicle storage costs if needed in order to calculate a total quote toward the vehicle. All these conditions are considered when calculating adjusted value of the vehicle. Then it is determined if there are any modifications to the total quote to be made. After all calculations, estimations and modifications are included, the total quote is sent to the client and saved to database 12. A brief overview of one exemplary process is as follows: 1) retrieve the estimated value based upon year, make/model and curb weight; 2) retrieve the estimated adjusted value based upon extra and missing parts, re-buildable parts and parts requested by a customer; 3) retrieve the estimated freight costs; 4) retrieve the estimated storage costs if storage was needed; 5) calculate a total quote of the value of the vehicle; 6) determine if any modifications to the total quote should be made and make them if necessary; 7) send the total quote to the client; 8) save the total quote data to database 12; and 9) done.

First at step 201, the quote process 200 is initialized. This initialization includes the startup routines and processes embedded in the BIOS of the server 11. The initialization also includes the establishment of data values for particular data structures utilized in the quote process 200.

At step 202, the quote process 200 waits to receive a quote transaction. Once a quote transaction has been received, the quote process 200 then retrieves the client information stored in database 12, at step 203. At step 204, the quote process 200 retrieves the estimated vehicle value based upon year, make/model and curb weight of the vehicle. At step 205, the quote process 200 retrieves estimated adjusted value of the vehicle based upon extra and missing parts, re-buildable parts and parts requested by a customer. The extra parts include, but are not limited to, catalytic converter, aluminum wheels, and the like. The vehicle re-buildable parts are those core parts that can be reused after servicing. The vehicle requested parts include parts requested by a customer. The value of the requested parts or the vehicle is generally a percentage of the quoted price the customer would pay for the desired part/vehicle. The valuation percentage is generally in the range of 20%-80% of the quoted price. However, historical data stored within the vehicle valuation management system 100 of the present invention can also be utilized to calculate the value of the requested parts or the vehicle.

At step 206, the quote process 200 retrieves the estimated freight costs for the vehicle selected. At step 207, the quote process 200 retrieves the estimated storage costs of the vehicle if storage was needed. At step 211, the quote process 200 calculates a total quote of the value of the vehicle. At step 212, it is determined if any modifications to the total quote are to be applied. Reasons for modifying the total quote include, but are not limited to, a premium adjustment for high volume clients, discount adjustment for low volume client/clients with history of distorting condition of vehicle and the like. If it is determined in step 212 that there are no modifications to be made to the total quote, then the quote process 200 skips to step 214. However, if it is determined at step 212 that modifications to the total quote are to be made, and the total quote is modified at step 213.

At step 214, the quote process 200 generates a quote and sends the total quote to the client. At step 215, that total quote is saved to database 12 for later retrieval and historical information.

At step 216, it is determined if the quote process 200 is to wait for additional vehicle quote transactions. If it is determined at step 216 that the quote process 200 is to wait for additional vehicle quote transactions, then the quote process 200 returns to repeat steps 202 through 216. However, if it is determined at step 216 that there are no more vehicle quote transactions to be received, then the quote process 200 exits at step 219.

FIG. 9 is a flow chart illustrating an example of the operation of the specific part request process 220 on the server 11 that is utilized in the vehicle valuation management system 100 of the present invention, as shown in FIGS. 2A-3. The specific part request process 220 enables a customer to request a specific part by make/model/year or vehicle by make/model/year. A brief overview of one exemplary process is as follows: 1) determine if the customer requesting a specific part or vehicle is a new customer, and if so, perform the client configure process; 2) determine if the customer requests a specific part; 3) if the customer requests a specific part, accept input identifying the specific part by make, model and year; 4) determine if the customer requests another specific part, and repeat step 3 if the customer requests another specific part; 5) save the customer requested specific part list after the customer has identified that there are no more specific parts requested; 6) determine if the customer is requesting a specific vehicle; 7) if the customer requests a specific vehicle, accept input identifying the specific vehicle by make, model and year; 8) determine if the customer requests another specific vehicle and repeat step 7 if the customer requests another specific vehicle; 9) save the customer requested specific vehicle list after the customer has identified that there are no more specific vehicles requested; and 10) done.

First at step 221, the specific part request process 220 is initialized. This initialization includes the startup routines and processes embedded in the BIOS of the server 11. The initialization also includes the establishment of data values for particular data structures utilized in the specific part request process 220.

At step 222, the specific part request process 220 waits to receive a specific part request transaction. Once a specific part request transaction has been received, the specific part request process 220 then verifies that the customer's account exists at step 223. If the customer's account exists, then the specific part request process 220 skips to step 225. However, if a customer's account does not exist for the new customer, then the client configure process 120 is performed at step 224.

At step 225, the specific part request process 220 determines if the customer requests a specific part. If it is determined in step 225 that the customer did not request a specific part, then the specific part request process 220 skips to step 231. However, if it is determined at step 225 that the customer did request a specific part, then the customer is prompted to input the requested part for a specific make, model and year of vehicle, at step 226. At step 227, it is determined if the customer requests another specific part. If it is determined that the customer requests another specific part, then the specific part request process 220 returns to repeat steps 226-227. However, if it is determined that the customer did not request another specific part at step 227, then the specific part request process 220 then saves the customer requested specific part list to database 12, at step 228.

At step 231, the specific part request process 220 determines if the customer requests a specific vehicle. If it is determined in step 231 that the customer did not request a specific vehicle, then the specific part request process 220 skips to step 235. However, if it is determined at step 231 that the customer did request a specific vehicle, then the customer is prompted to input the requested vehicle by a specific make, model and year of the vehicle, at step 232. At step 233, it is determined if the customer requests another specific vehicle. If it is determined that the customer requests another specific vehicle, then the specific part request process 220 returns to repeat steps 232-233. However, if it is determined that the customer did not request another specific vehicle at step 233, then the specific part request process 220 saves the customer requested specific vehicle to database 12, at step 234.

At step 235, it is determined if the specific part request process 220 is to wait for additional specific part request transactions. If it is determined at step 235 that the specific part request process 220 is to wait for additional specific part request transactions, then the specific part request process 220 returns to repeat steps 222 through 235. However, if it is determined at step 235 that there are no more specific part request transactions to be received, then the specific part request process 220 exits at step 239.

FIG. 10 is a flow chart illustrating an example of the operation of the vehicle status reports process 240 on the server 11 that is utilized in vehicle valuation management system 100 of the present invention, as shown in FIGS. 2A-3. In one embodiment, a vehicle status report action enables management to receive reports with regard to a specific vehicle location, all vehicle locations, a list of specific parts requested, a list of specific vehicles requested, and the like. A brief overview of one exemplary process is as follows: 1) determine if a specific vehicle request has been received; 2) if a specific vehicle request was received, provide a specific vehicle report by current location, destination location, ETA to destination point, vehicle specifics including but not limited to, make/model/year of vehicle, curb weight of vehicle, original equipment parts, condition of vehicle, extra parts of vehicle, missing parts of vehicle, core parts of vehicle, towing costs of vehicle, storage costs of vehicle, and the like; 3) determine if a all vehicles location report request is received and provide the report by, but not limited to, origination point, destination point, ETA to destination point, and the like; 4) determine if a specific parts list report is requested and provide the report by, but not limited to, origination point, destination point, ETA to destination point, and the like; 5) determine if a specific vehicles list report is requested and then provide the report by, but not limited to, origination point, destination point, ETA to destination point, and the like; and 6) done.

At step 301, the vehicle status reports process 240 is initialized. This initialization includes the startup routines and processes embedded in the BIOS of the server 11. The initialization also includes the establishment of data values for particular data structures utilized in the vehicle status reports process 240.

At step 242, the vehicle status reports process 240 waits to receive a report request. Once a report request has been received, the vehicle status reports process 240 then determines if a vehicle location report request has been received at step 243. If it is determined that a vehicle location report request was not received, then the vehicle status reports process 240 skips to step 246. However, if it is determined at step 243 that a vehicle location report request has been made, then the vehicle status reports process 240 invites the user to input the vehicle parameters to search for the specific vehicle by VIN, make and/or model and/or year, client account or the like at step 244. The vehicle status report process 240 then creates a vehicle location report for a specific vehicle by current location, destination location, ETA to destination point, vehicle specifics in the like. Vehicle specifics include, but are not limited to, make/model/year of vehicle, curb weight of vehicle, original equipment parts, condition of vehicle, extra parts of vehicle, missing parts of vehicle, core part of vehicle, towing cost of vehicle, storage cost of vehicle, and the like. The vehicle status reports process 240 then skips to step 255 to determine if the vehicle status reports process 240 is to wait to receive a new report request.

At step 246, the vehicle status reports process 240 determines if an all vehicles location report request has been received. If it is determined that an all vehicle location report request was not received, then the vehicle status reports process 240 skips to step 251. However, if it is determined at step 246 that an all vehicles location report request has been made, then the vehicle status reports process 240 searches database 12 to determine the location of all vehicles by current location at step 247. The vehicle status reports process 240 then creates an all vehicle location report for all vehicles by current location, destination location, ETA to destination point, vehicle specifics and the like. Vehicle specifics including, but not limited to, make/model/year of vehicle, curb weight of vehicle, original equipment parts, condition of vehicle, extra parts of vehicle, missing parts of vehicle, core parts of vehicle, towing cost of vehicle, storage cost of vehicle, and the like. The vehicle status reports process 240 then skips to step 255 to determine if the vehicle status reports process 240 is to wait to receive a new report request.

At step 251, the vehicle status reports process 240 determines if a specific parts list report request has been received. If it is determined that a specific parts list report request was not received, then the vehicle status reports process 240 skips to step 253. However, if it is determined at step 251 that a specific parts list report request has been made, then the vehicle status reports process 240 searches database 12 to determine all current specific parts requested by customers at step 252. The vehicle status reports process 240 then creates a current specific parts list requested by customers by, but not limited to: customer requesting the specific part, a list of all parts requested by a customer, make/model/year vehicle the requested part comes from; ETA to deliver the requested part to a customer, cost to obtain the part, charge amount to the customer for the part and the like. The vehicle status reports process 240 then skips to step 255 to determine if the vehicle status reports process 240 is to wait to receive a new report request.

At step 253, the vehicle status reports process 240 determines if a list of specific vehicles report request has been received. If it is determined that a list of specific vehicles request was not received, then the vehicle status reports process 240 skips to step 255. However, if it is determined at step 253 that a list of specific vehicles report request has been made, then the vehicle status reports process 240 searches database 12 to determine all current specific vehicles requested by customers at step 254. The vehicle status reports process 240 then creates a current specific vehicle list requested by customers by, but not limited to, customer requesting the specific vehicle, a list of all vehicles requested by a customer, make/model/year of the vehicles requested; ETA to deliver the requested vehicle to a customer, cost to obtain the vehicle, charge amount to the customer for the vehicle and the like.

At step 255, it is determined if the vehicle status reports process 240 is to wait for additional report requests. If it is determined at step 255 that the vehicle status reports process 240 is to wait for additional report requests, then the vehicle status reports process 240 returns to repeat steps 242 through 255. However, if it is determined at step 255 that there are no more report requests to be received, then the vehicle status reports process 240 then exits at step 259.

Any process descriptions or blocks in flow charts should be understood as representing modules, segments, or portions of code which include one or more executable instructions for implementing specific logical functions or steps in the process, and alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and are protected by the following claims.

1. A method for delivering vehicle valuation management embodied in a computer program product for execution on an instruction processing system, comprising a tangible storage medium readable by the instruction processing system and storing instructions for execution by the instruction processing system for performing the method comprising:
receiving a request from a client for a value quote of a vehicle;
determining the curb weight of the vehicle;
determining estimated freight cost to obtain the vehicle; and
sending the value quote of the vehicle to the client.

2. The method of claim 1, wherein the determining the curb weight of the vehicle further comprises:
calculating a value of the vehicle based upon curb weight.

3. The method of claim 2, wherein the determining the curb weight of the vehicle further comprises:
determining the year, make and model of the vehicle.

4. The method of claim 3, wherein the determining the year, make and model of the vehicle further comprises:
determining if a vehicle identification number is known for the vehicle and decoding the vehicle identification number to obtain the year, make and model of the vehicle; and
determining the curb weight of the vehicle from the year, make and model of the vehicle.

5. The method of claim 4, wherein the step determining if a vehicle identification number is known for the vehicle further comprises:
determining if the vehicle was reported stolen or has a lien.

6. The method of claim 1, further comprising:
determining if the vehicle has adjustable value, wherein determining the adjustable value further comprises:
calculating an increased to the adjustable value of the vehicle for any extra parts on the vehicle; and
calculating a decreased to the adjustable value of the vehicle for any missing parts to the vehicle.

7. The method of claim 1, further comprising:
calculating a most cost effective location to ship the vehicle to, wherein calculating the most cost effective location to ship the vehicle to further comprises:
determining if a closest site to the vehicle is a final destination, and if the closest site is the final destination calculate a first transportation cost to the final destination;
determining if the closest site to the vehicle is not the final destination, calculate a second transportation cost to the closest site and calculate a third transportation cost from closest site to the final destination, wherein indirect transportation route cost is the second transportation cost plus the third transportation cost;
determining if the closest site to the vehicle is not the final destination, calculate a fourth transportation cost to the final destination;
determining if the closest site to the vehicle is the final destination then the first transportation cost is the most cost effective location to ship the vehicle to; and
determining if the closest site to the vehicle is not the final destination, compare the indirect transportation route cost to the fourth transportation cost, wherein the most cost effective location to ship the vehicle to is a smaller amount.

8. The method of claim 1, further comprising:
determining if the vehicle has an original equipment manufacture's catalytic converter, wherein the adjustable value of the vehicle is increased if the vehicle has the original equipment manufacture's catalytic converter, and wherein the adjustable value of the vehicle is decreased if the vehicle is missing the original equipment manufacture's catalytic converter.

9. The method of claim 1, further comprising:
determining if the vehicle has rebuildable parts, wherein the adjustable value of the vehicle is increased if the vehicle has the rebuildable parts.

10. The method of claim 1, further comprising:
determining if the vehicle has requested parts, wherein the adjustable value of the vehicle is increased if the vehicle has the requested parts.

11. A system for providing vehicle valuation management services on a computer system, comprising:
a tangible storage medium readable by the computer system and storing instructions for execution by the computer system;
a means for receiving a request from a client for a value quote of a vehicle;
a means for determining the curb weight of the vehicle;
a means for determining estimated freight cost to obtain the vehicle; and
a means for sending the value quote of the vehicle to the client.

12. The system of claim 11, wherein, wherein the means for determining the curb weight of the vehicle further comprises:
means for calculating a value of the vehicle based upon curb weight.

13. The system of claim 12, wherein the means for determining the curb weight of the vehicle further comprises:
means for determining the year, make and model of the vehicle.

14. The system of claim 13, wherein the means for determining the year, make and model of the vehicle further comprises:
means for determining if a vehicle identification number is known for the vehicle and decoding the vehicle identification number to obtain the year, make and model of the vehicle; and
means for determining the curb weight of the vehicle from the year, make and model of the vehicle.

15. The system of claim 14, wherein the means for determining if a vehicle identification number is known for the vehicle further comprises:
means for determining if the vehicle was reported stolen or has a lien.

16. The system of claim 11, further comprising:
means for determining if the vehicle has adjustable value, wherein means for determining the adjustable value further comprises:
means for calculating an increased to the adjustable value of the vehicle for any extra parts on the vehicle; and
means for calculating a decreased to the adjustable value of the vehicle for any missing parts to the vehicle.

17. The method of claim 11, further comprising:
calculating a most cost effective location to ship the vehicle to, wherein calculating the most cost effective location to ship the vehicle to further comprises:
determining if a closest site to the vehicle is a final destination, and if the closest site is the final destination calculate a first transportation cost to the final destination;
determining if the closest site to the vehicle is not the final destination, calculate a second transportation cost to the closest site and calculate a third transportation cost from closest site to the final destination, wherein indirect transportation route cost is the second transportation cost plus the third transportation cost;
determining if the closest site to the vehicle is not the final destination, calculate a fourth transportation cost to the final destination;
determining if the closest site to the vehicle is the final destination then the first transportation cost is the most cost effective location to ship the vehicle to; and
determining if the closest site to the vehicle is not the final destination, compare the indirect transportation route cost to the fourth transportation cost, wherein the most cost effective location to ship the vehicle to is a smaller amount.

18. The system of claim 11, further comprising:
means for determining if the vehicle has an original equipment manufacture's catalytic converter, wherein the adjustable value of the vehicle is increased if the vehicle has the original equipment manufacture's catalytic converter, and wherein the adjustable value of the vehicle is decreased if the vehicle is missing the original equipment manufacture's catalytic converter.

19. The system of claim 11, further comprising:
means for determining if the vehicle has rebuildable parts, wherein the adjustable value of the vehicle is increased if the vehicle has the rebuildable parts.

20. The system of claim 11, further comprising:
means for determining if the vehicle has requested parts, wherein the adjustable value of the vehicle is increased if the vehicle has the requested parts.
